(19) United States
(12) Patent Application Publication
(10) Pub. No.: US 2016/0355184 A1
(43) Pub. Date: Dec. 8, 2016

(54) Mine Truck to Mine Truck Communication

(71) Applicant: Caterpillar Inc., Peoria, IL (US)

(72) Inventor: Eric J. Ruth, Peoria, IL (US)

(73) Assignee: Caterpillar Inc., Peoria, IL (US)

(21) Appl. No.: 14/729,311

(22) Filed: Jun. 3, 2015

(51) Int. Cl. B60W 30/16; B60W 10/18; G05D 1/02; B60W 10/04

(52) U.S. Cl. CPC B60W 30/162; B60W 10/04; B60W 10/18; G05D 1/0289; G05D 1/0293; B60W 2550/302; B60W 2550/308; B60W 2550/306; B60W 2720/10; B60W 2710/18; B60W 2710/06

(57) ABSTRACT

A method for monitoring and controlling a plurality of mining trucks, while the mining trucks operate on a worksite, is disclosed. The plurality of mining trucks includes, at least, a first truck and a second truck. The method includes monitoring a first speed of the first truck and determining a second speed of the second truck based on, at least, the first speed. The method further includes modulating the second speed based on changes to the first speed and controlling propulsion of the second truck based on the second speed.

### TECHNICAL FIELD

The present disclosure generally relates to control systems for mining trucks and, more particularly, relates to systems and methods for monitoring and controlling speeds of multiple mining trucks while the trucks operate on a worksite.

### BACKGROUND

Mining trucks are, generally, used at mining sites to move large quantities of materials from one area of a worksite to another. Large scale mining operations may employ an increasingly large fleet of mining trucks to achieve mining production targets in shorter periods of time. In some large scale sites, these increasingly large fleets of mining trucks may include hundreds of trucks. However, having such great quantities of trucks not only creates a burden on operational costs (employee costs, fuel for the trucks, maintenance cost, etc.), but the large quantities of trucks may also lead to traffic issues on the mining worksite.

Often, the mining worksite may only have a limited number of haul roads available to the large fleet of mining trucks. Having a large number of trucks, that create heavy traffic on a limited number of haul roads, may result in each haul of each truck taking a longer period of time, in comparison to the period of time for a haul when mining with fewer trucks. Due to size constraints of the haul roads and the mining worksite at large, mining operations are often unable to add additional trucks to the fleet to increase productivity towards the production target.

Productivity could be increased by using even larger trucks (e.g., mining trucks exceeding 500 tons in weight), instead of adding additional trucks; however, such larger trucks may be cost prohibitive due to the additional materials needed for production and the specialized tools needed for maintenance. Further, larger, heavier trucks may create new traffic issues on the worksite, as braking times and acceleration times for the heavy trucks may be slower, thusly necessitating longer following distances between trucks.

Instead, to increase productivity of a fleet of mining trucks on a worksite, autonomous and/or semi-autonomous control methods may be employed. Autonomous or semi-autonomous have been used for aiding with safety on the worksite. For example, Canadian Patent CA 2041373 (“Vehicle Guidance System”) details a control system for mining trucks which employs sensors and laser units as a guidance system for a mining truck to keep the truck on a path and avoid collision with other trucks. While such systems may effectively keep a truck on a given path and avoid collisions during following, improvements to traffic patterns and following distance in mining environments are needed.

Therefore, systems and methods for monitoring and controlling speed of multiple mining trucks at a worksite for improved spacing and traffic management are desired.

### SUMMARY

In accordance with one aspect of the disclosure, a method for monitoring and controlling a plurality of mining trucks, while the mining trucks operate on a worksite, is disclosed. The plurality of mining trucks may include, at least, a first truck and a second truck. The method may include monitoring a first speed of the first truck and determining a second speed of the second truck based on, at least, the first speed. The method may further include modulating the second speed based on changes to the first speed and controlling propulsion of the second truck based on the second speed.

In accordance with another aspect of the disclosure, a method for monitoring and controlling a plurality of mining trucks, while the mining trucks operate on a worksite, is disclosed. The plurality of mining trucks may include, at least, a first truck and a second truck. The worksite may include a first road and a second road, the first road and second road intersecting at an intersection. The first truck may travel on the first road towards the intersection, while the second truck may travel on the second road towards the intersection. The method may include monitoring a first speed of the first truck and determining a timeframe in which the first truck will reach the intersection based on the first speed. The method may further include determining a second speed of the second truck based on, at least, the first speed and the time frame and controlling propulsion of the second truck based on the second speed.

In accordance with yet another aspect of the disclosure, a system for monitoring and controlling a plurality of mining trucks while the plurality of mining trucks operate on a worksite is disclosed. The plurality of mining trucks may include, at least, a first truck and a second truck. The system may include a network communication system configured to enable communication amongst the plurality of mining trucks. The system may further include a plurality of controllers, each of the plurality of controllers being operatively associated with one of the plurality of mining trucks. The plurality of controllers may include, at least, a first controller operatively associated with the first truck and a second controller operatively associated with the second truck. The plurality of controllers may be in communication via the network communication system. The plurality of controllers may be configured to control propulsion of the first truck based on a first speed, communicate the first speed amongst the plurality of mining trucks via the network communication system, determine a second speed for the second truck based on, at least, the first speed, and control propulsion of the second truck based on the second speed.

### BRIEF DESCRIPTION OF THE DRAWINGS

FIG. 1 is a side view of a plurality of mining trucks and an associated system for monitoring and controlling the plurality of mining trucks, in accordance with an embodiment of the disclosure.

FIG. 2 is a schematic diagram of the system for monitoring and controlling the plurality of mining trucks of FIG. 1, in accordance with the embodiment of FIG. 1.

FIG. 3 is a flowchart illustrating a method for monitoring and controlling a plurality of mining trucks, in accordance with an embodiment of the disclosure.

FIG. 4 is a side view of an example plurality of mining trucks operating on a substantially level worksite.

FIG. 5 is a side view of an example plurality of mining trucks operating on an uphill grade worksite.

FIG. 6 is a side view of an example plurality of mining trucks operating on a downhill grade worksite.

FIG. 7 is a flowchart illustrating a method for monitoring and controlling a third truck of the plurality of mining trucks of FIG. 3, with respect to a second truck of the plurality of mining trucks, in conjunction and accordance with the embodiment of FIG. 3.

FIG. 8 is a flowchart illustrating a method for monitoring and controlling a nth truck of the plurality of mining trucks of FIG. 3, with respect to a (n-1)th truck of the plurality of mining trucks, in conjunction and accordance with the embodiment of FIG. 3.

FIG. 9 is a flowchart illustrating a method for monitoring and controlling a plurality of mining trucks, in accordance with an embodiment of the disclosure.

FIG. 10 is a schematic map showing a worksite having two roads intersecting at an intersection and a plurality of mining trucks travelling on the two roads, in conjunction with the method of FIG. 9.

### DETAILED DESCRIPTION

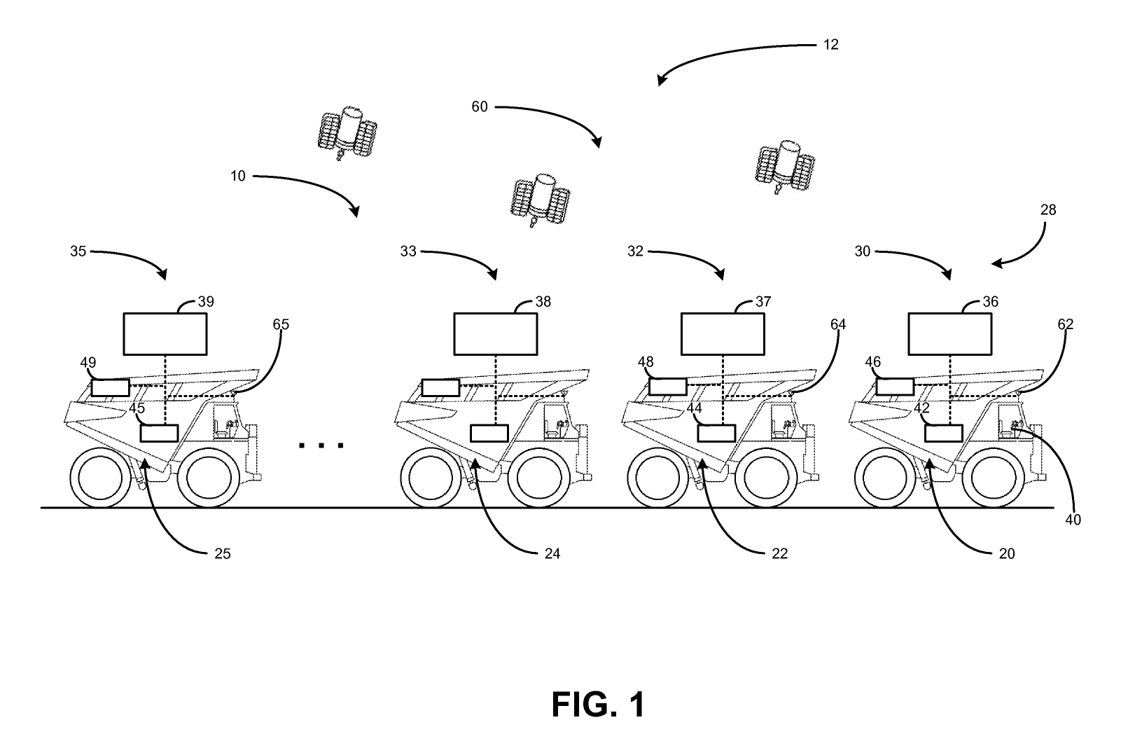

Turning now to the drawings and with specific reference to FIG. 1, a plurality of mining trucks 10 and a system 12 for monitoring and controlling operations of the plurality of mining trucks 10 on a worksite 14 are shown. In the illustrated embodiment, the mining trucks 10 are any truck used on the worksite 14 for large scale material movement. The plurality of mining trucks 10 includes, at least, a first mining truck 20 and a second mining truck 22. Additionally, the plurality of mining trucks 10 may include any number of additional mining trucks, such as the third mining truck 24. In fact, the plurality of mining trucks 10 may include n number of mining trucks, as represented by an nth mining truck 25.

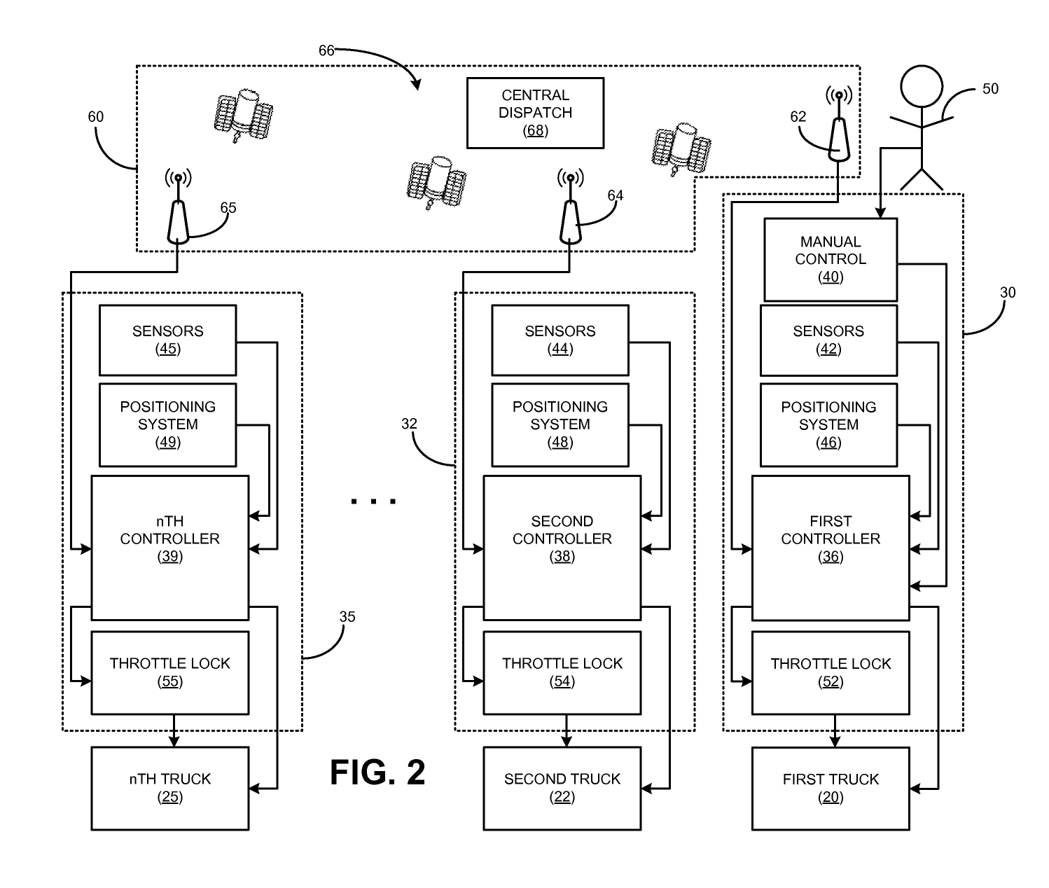

While the connections between elements of the system 12 are best shown in the schematic view of FIG. 2, some elements are also represented in FIG. 1 and denoted, schematically, by boxes associated with each of the plurality of mining trucks 10. The system 12 may be used to control each of the plurality of mining trucks 10 in a variety of autonomous, semi-autonomous, or manual modes. As used herein, each of the plurality of mining trucks 10 operating in an autonomous manner operates automatically based upon information provided by the system 12, without the need for human operator input. Further, each of the plurality of mining trucks 10 operating semi-autonomously includes an operator, either within one or more of the plurality of mining trucks 10 or remotely, who performs some tasks or provides some input while other tasks are performed automatically based upon information provided by the system 12. Each of the plurality of mining trucks 10 being operated manually is one in which an operator is controlling all or essentially all of the direction, speed, and manipulating functions of the member of the plurality of mining trucks 10.

Each of the plurality of mining trucks 10 may be associated with a control system 28. For example, a plurality of control systems 28 may be provided and includes, at least, a first control system 30 associated with the first mining truck 20, a second control system 32, associated with the second mining truck 22. A third control system 33 associated with a third mining truck 24 may also be provided. Of course, the plurality of control systems 28 may include n number of control systems, as represented by the nth control system 35 associated with the nth mining truck 25.

Control systems 30, 32, 33, 35 each include a controller, as represented by a first controller 36 of the first control system 30, a second controller 37 of the second control system 32, a third controller 38 of the third control system 33, and a nth controller 39 of the nth control system 35. Operation of the plurality of mining trucks 10, in any autonomous, semi-autonomous, or manual modes and/or in conjunction with any of the proceeding methods disclosed herein, may be executed by the controllers 36, 37, 38, 39, as will be herein described. The controllers 36, 37, 38, 39 may be any electronic controller or computing system including a processor which operates to perform operations, executes control algorithms, stores data, retrieves data, gathers data, and/or performs any other computing or controlling task desired. The controllers 36, 37, 38, 39 may be a single controller or may include more than one controller disposed to control various functions and/or features of the plurality of mining trucks 10. Functionality of the controllers 36, 37, 38, 39 may be implemented in hardware and/or software and may rely on one or more data maps relating to the operation of the plurality of mining trucks 10. To that end, the controllers 36, 37, 38, 39 may include internal memory and/or the controllers 36, 37, 38, 39 may be otherwise connected to external memory, such as a database or server. The internal memory and/or external memory may include, but are not limited to including, one or more of read only memory (ROM), random access memory (RAM), a portable memory, and the like. Such memory media are examples of nontransitory memory media.

The controllers 36, 37, 38, 39 each are operatively associated with their respective mining trucks 20, 22, 25. For gathering data associated with the plurality of mining trucks 10, each of the controllers 36, 37, 38, 39 may receive input data associated with their respective mining trucks 20, 22, 25. The input data may come from, for example, a manual control mechanism 40, sensors 42, 44, 45, and/or positioning systems 46, 48, 49. The input data may be processed by the controllers 36, 37, 38, 39 to provide propulsion instructions for the respective mining trucks 20, 22, 25.

The manual control mechanism 40 may be included with the first control system 30 so that an operator 50 may have the ability to operate the machine. For example, the manual control mechanism 40 may be located in a cab of the mining truck 20, wherein an operator 50 may provide commands when the mining truck 20 is operating in either a manual or semi-autonomous manner. The manual control mechanism 40 may include one or more input devices through which the operator 50 may issue commands to control the propulsion of the mining truck 20. For example, the manual control mechanism 40 may be a pedal, a lever, a control program on a display associated with the controller 36, or any other mechanism with which the operator 50 may manually request a propulsion speed for the mining truck 20.

The sensors 42, 44, 45 may be used to gather information associated with conditions of the machine and transmit such information to the controllers 36, 37, 38, 39. The sensors 42, 44, 45 may be any sensors capable of determining characteristics and/or conditions of members of the plurality of mining trucks 10, such as, but not limited to ground speed of a member of the plurality of mining trucks 10, a load associated with a member of the plurality of mining trucks 10, momentum of a member of the plurality of mining trucks 10 when the member enters a road of the worksite 14 from a grade of the worksite 14, engine health of a member of the plurality of mining trucks 10, propulsion capabilities of a member of the plurality of mining trucks 10, drive system torque capabilities of a member of the plurality of mining trucks 10, braking capabilities of a member of the plurality of mining trucks 10, and/or any other condition or characteristic of a member of the plurality of mining trucks 10 that may affect propulsion or speed. Such sensors 42, 44, 45 may include engine speed sensors, speedometers, odometers, accelerometers, engine health sensors, pressure sensors, brake sensors, and/or any other sensor capable of providing relevant data associated with the plurality of mining trucks 10 to one or more of the controllers 36, 37, 38, 39.

Additionally, the positioning systems 46, 48, 49 are provided to gather position-related data associated with the plurality of mining trucks 10. The positioning systems 46, 48, 49 may include a plurality of individual sensors that cooperate to provide signals to the controllers 36, 37, 38, 39 to indicate the positions of the plurality of mining trucks 10 and/or map characteristics of the worksite 14, such as topography of the worksite 14 and/or traffic patterns of the plurality of mining trucks 10 on the worksite 14. The positioning systems 46, 48, 49 may include global positioning systems (“GPS”), laser position detection systems, radar systems, LIDAR systems, advanced distance sensors, proximity sensors, cameras, and/or any other system or method for detecting positioning of a member of the plurality of mining trucks 10 relative to the worksite 14 and/or other members of the plurality of mining trucks 10. The positioning systems 46, 48, 49 may provide information to be used in concert with information from the sensors 42, 44, 45 to determine operating conditions or characteristics associated with the plurality of mining trucks 10. Positioning data provided by the positioning systems 46, 48, 49 may also be useful in determining traffic characteristics, such as, but not limited to, spacing between members of the plurality of mining trucks 10 as the plurality of mining trucks 10 operate on the worksite 14 and/or arrival information of multiple members of the plurality of mining trucks 10 as they approach an intersection. Further, the controllers 36, 37, 38, 39 may track positioning data versus time to determine a speed of their respective mining trucks 20, 22, 25. Of course, the controllers 36, 37, 38, 39 are not limited to determine speed of the mining trucks 20, 22, 25 in such a manner and the controllers 36, 37, 38, 39 may use any known associated sensor, method, or apparatus to determine speed of the mining trucks 20, 22, 25.

Using information from one or more of the manual control mechanism 40, the sensors 42, and the positioning system 46, the first controller 36 may determine a first speed for the first mining truck 20. For example, if the first mining truck 20 is a lead truck, behind which members of the plurality of mining trucks 10 follow, the first controller 36 may primarily use instructions from the manual control mechanism 40 to determine the first speed. Using the determined first speed, the first controller 36 may then control propulsion of the first mining truck 20 based on the first speed.

Propulsion control of the first, second, and nth mining trucks 20, 22, 25 may be performed in conjunction with respectively associated throttle lock features 52, 54, 55. Throttle lock features 52, 54, 55 may be a features of drives of the respective associated mining truck 20, 22, 25 which locks the rate of revolutions per minute (RPM) of the drive using electronic controls. Throttle lock features 52, 54, 55 may be employed to set a machine at a peak efficiency for propulsion during autonomous or semi-autonomous control of the mining trucks 20, 22, 25.

For enabling communication amongst the plurality of mining trucks 10, via the controllers 36, 37, 38, 39, the system 12 may further include a network communication system 60. The network communication system 60 may include wireless connectivity linkages 62, 64, 65, each associated with respective mining trucks 20, 22, 25. The wireless connectivity linkages 62, 64, 65 may all connect to a common wireless network 66 and their respective associated controllers 36, 37, 38, 39, so that each of the controllers 36, 37, 38, 39 may communicate with one another and share data amongst the controllers 36, 37, 38, 39. The wireless network 66 may be any non-wired network such as the Internet, a WLAN, a WAN, a personal network, or any other network for connecting the controllers 36, 37, 38, 39 to each other and/or to any other controller or capable computing device.

In some examples, communication amongst the plurality of mining trucks 10 may include routing communications to and from a central dispatch 68 of the network communication system 60. The central dispatch 68 may receive information from any of the controllers 36, 37, 38, 39 and may also send information to any of the controllers 36, 37, 38, and 39. Of course, the central dispatch 68 is not necessary and the controllers 36, 37, 38, and 39 may communicate with one another via direct communication using the network communication system 60.

The central dispatch 68 may include one or more controllers configured to relay information (e.g., positioning data of the plurality of mining trucks 10), link members of the plurality of mining trucks 10, approve truck-to-truck links, and/or break truck-to-truck links amongst the plurality of mining trucks 10. All such communication may be performed in conjunction with the network communication system 60. Functionality of the central dispatch 68 may be implemented in hardware and/or software and may rely on one or more data maps relating to inter-truck communication. To that end, the central dispatch 68 may include internal memory and/or the central dispatch 68 may be otherwise connected to external memory, such as a database or server. The internal memory and/or external memory may include, but are not limited to including, one or more of read only memory (ROM), random access memory (RAM), a portable memory, and the like. Such memory media are examples of nontransitory memory media.

Using positioning data from the positioning systems 46, 48, 49 and/or any other identification data, the controllers 36, 37, 38, 39 may all be given unique identifiers for use in communications via the network communication system 60. Using unique identifiers, the controllers 36, 37, 38, 39 may determine the source of information received. For example, if the second mining truck 22 is following the first mining truck 20, the second mining truck 22 may need to receive information from the first mining truck 20, receiving the information at the controller 37. However, the plurality of mining trucks 10 may include additional mining trucks aside from the first and second mining trucks 20, 22 (e.g., the third mining truck 24, the nth mining truck 25) and, thusly, must identify the source of information that it will be using to control the second mining truck 22. If the first mining truck 20 has such a unique identifier, then the second mining truck 22 can know that it is receiving the correct information necessary to follow the first mining truck 20. Such information can be determined using, for example, positioning data associated with any number of mining trucks of the plurality of mining trucks 10. Additionally, some examples may include routing such information through the central dispatch 68 to communicate requests to follow using the system 12 and/or employing the foregoing methods.

By utilizing such connectivity amongst the controllers 36, 37, 38, 39 provided by the network communication system 60, the system 12 is capable of communicating information, such as the first speed of the first mining truck 20, amongst the plurality of mining trucks 10, via their respective controllers 36, 37, 38, 39. For example, one or more of the controllers 36, 37, 38, 39 may be used to determine a second speed for the second mining truck 22 based on, at least, the communicated first speed. Using this determined second speed, the second controller 37 may autonomously control propulsion of the second mining truck 22 based on the second speed. Further, additional or alternative methods for monitoring and controlling the plurality of mining trucks 10 are also disclosed herein and may be implemented using the system 12.

### INDUSTRIAL APPLICABILITY

The present disclosure relates generally to control systems for mining trucks and, more particularly, relates to systems and methods for monitoring and controlling speeds of mining trucks while the trucks operate on a worksite. The foregoing is applicable to mining truck operations occurring on worksites, wherein a plurality of mining trucks operates in various traffic patterns.

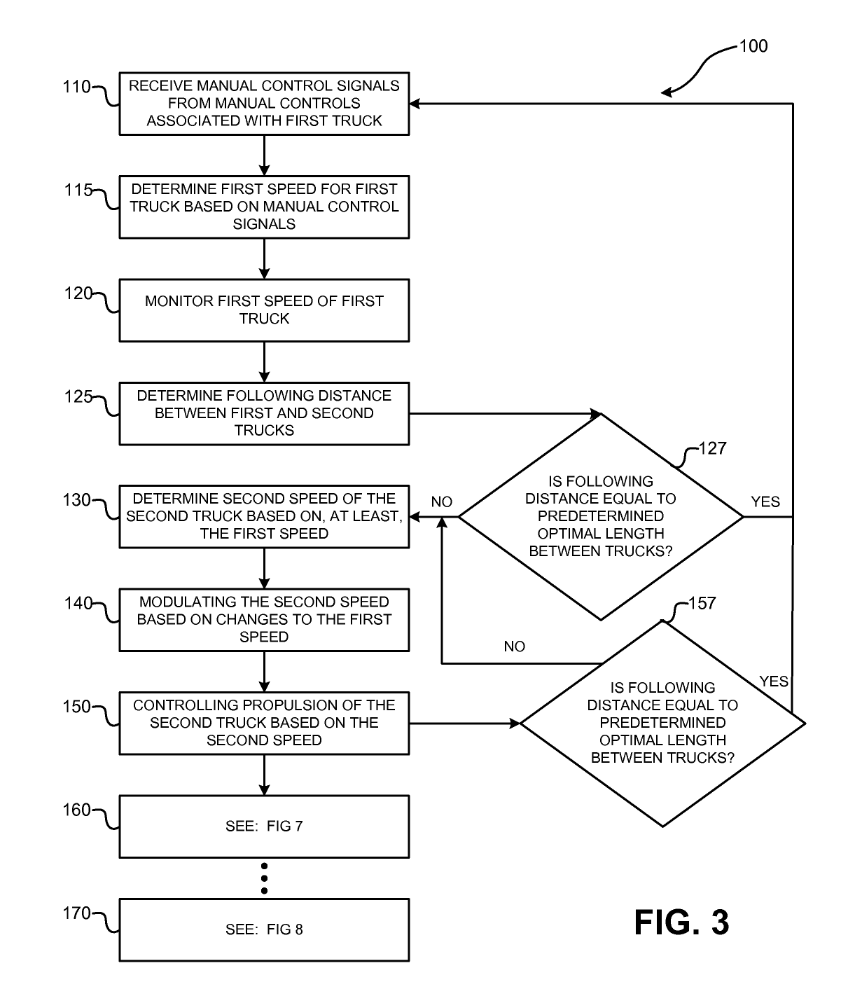

Turning to FIG. 3, a method 100 for monitoring and controlling members of the plurality of mining trucks 10 is shown, illustrated as a flowchart. The method 100 may be instructions stored on an internal or external memory associated with one or more of the controllers 36, 37, 38, 39 and executed by one or more of the controllers 36, 37, 38, 39. Such instructions may be communicated amongst the controllers 36, 37, 38, 39 via the network communication system 60. The method 100 is not limited to being executed by the above mentioned elements of the system 12, however, and may be implemented using any combination of autonomous, semi-autonomous, and/or manual controls.

In some examples, the system 12 may be configured such that the second mining truck 22 has automated propulsion control via the method 100 if one or more of the controllers 36, 37, 38, 39 determine that the second mining truck 22 is, at least, within a determined minimum distance from the first mining truck 20. The determined minimum distance may be the minimum distance between trucks wherein automated propulsion control of the second mining truck 22 is necessary. Additionally, in some examples, the system 12 may be configured to exit the method 100 if the distance between the first and second mining trucks 20, 22 exceeds a determined maximum distance, wherein, after the maximum distance, automated propulsion control is not necessary. In such examples, propulsion of the second mining truck 22 may then be controlled manually by an operator after exiting the method 100. Further, in methods where one or both of the determined maximum and minimum distances mentioned above are employed, such determined maximum and minimum distances may be determined by and/or communicated to the plurality of mining trucks 10 via the central dispatch 68.

As illustrated, the method 100 may begin with block 110, wherein control signals are received from manual control mechanism 40, which is associated with the first mining truck 20. The first controller 36 may then determine a first speed for the first mining truck 20 based on the manual control signals, as shown in block 115. While the method 100 is shown having blocks 110 and 115, blocks 110 and 115 may be omitted in certain control schemes, such as, but not limited to, control schemes in which the first speed for the first mining truck 20 is autonomously controlled or if the first mining truck 20 is previously operating at a set speed (e.g., an engaged cruise control).

The method 100 may monitor the first speed of the first mining truck 20, as shown in block 125. Monitoring the first speed may be accomplished using any of the sensors 42, 44, 45, the positioning systems 46, 48, 49, or any other sensor, method, or apparatus for determining speed of the first mining truck 20. Monitoring the first speed at block 125 may be executed by the first controller 36, but may also be executed by any additional controllers (e.g., controllers 37, 39) connected to the network communication system 60 and in communication with the first controller 36.

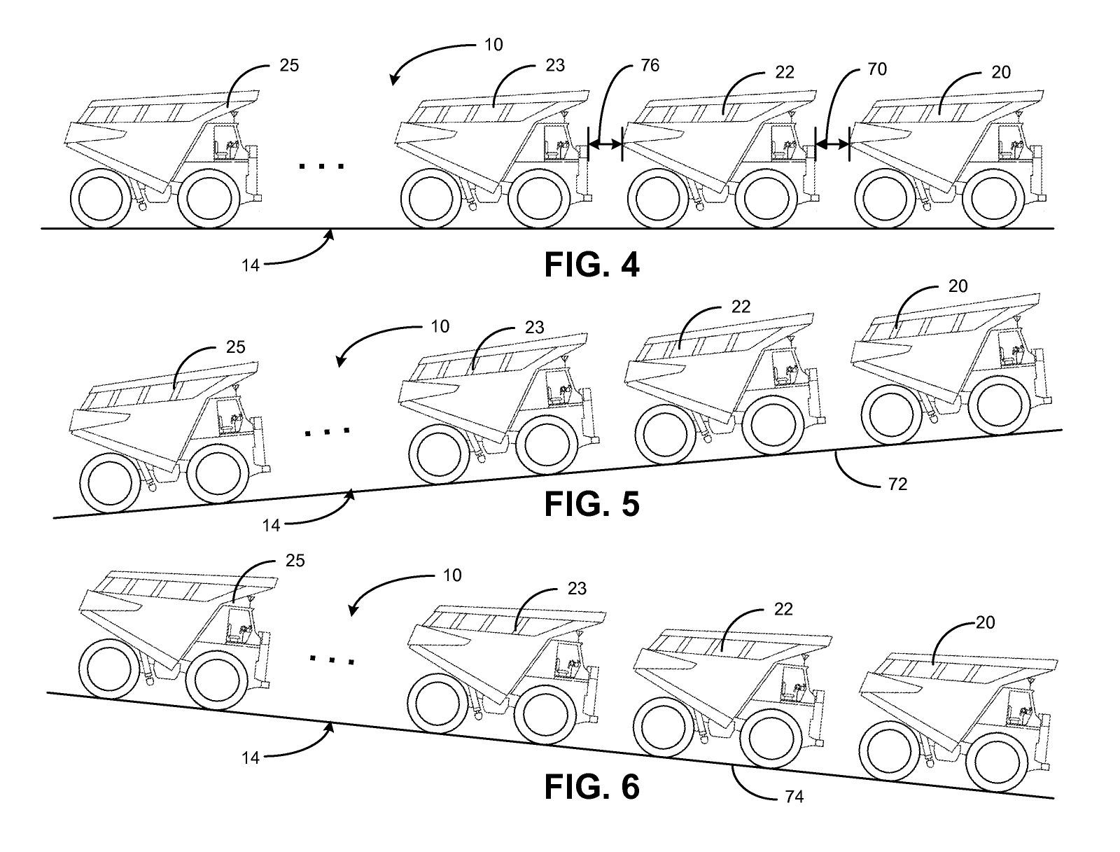

At block 125, a following distance 70 may be determined between the first mining truck 20 and the second mining truck 22. The following distance 70 is shown in FIG. 4, which depicts a traffic pattern for the plurality of mining trucks 10, wherein, at least, the second mining truck 22 follows the first mining truck 20 on the worksite 14. The following distance 70 may be a predetermined optimal length between the mining trucks 20, 22, which is to be maintained during following. For such optimization, the following distance 70 may be configured such that a mining operation at the worksite 14 may be able to fit more mining trucks on to the worksite 14, due to decreased following distance between mining trucks. The following distance 70 may be specifically configured based on operating conditions associated with one or both of the first mining truck 20 and the second mining truck 22. The operating condition may be, but is not limited to being, ground speed of a member of the plurality of mining trucks 10, a load associated with a member of the plurality of mining trucks 10, momentum of a member of the plurality of mining trucks 10 when the member enters a road of the worksite 14 from a grade of the worksite 14, engine health of a member of the plurality of mining trucks 10, propulsion capabilities of a member of the plurality of mining trucks 10, drive system torque capabilities of a member of the plurality of mining trucks 10, braking capabilities of a member of the plurality of mining trucks 10, and/or any other condition or characteristic of a member of the plurality of mining trucks 10 that may affect propulsion or speed.

After determining the following distance between the first and second mining trucks 20, 22, the method 100 determines if the following distance is equal to the predetermined optimal length between trucks, as shown in block 127. If the following distance is equal or substantially similar to the predetermined optimal length between trucks, then the method 100 returns to block 110. Otherwise, the method 100 continues to block 130. In some examples, determining if the following distance is equal to the predetermined optimal length between trucks may be performed by using elements of the positioning system(s) 46, 48 (e.g., utilizing one or more of cameras, radar systems, LIDAR systems, or any advanced distance sensor) to determine if the second mining truck 22 is following the first mining truck 20 at a safe and/or optimal distance.

At block 130, a second speed of the second mining truck 22 is determined based on, at least, the first speed of the first truck. Determination of the second speed may be performed at any controller 36, 37, and/or 39 connected to the network communication system 60. The second speed may be determined to be substantially similar to the first speed, such that the first mining truck 20 and second mining truck 22 maintain a consistent following distance, such as the following distance 70. In some examples, the second speed may be determined further based on the following distance 70. In such examples, the second speed may be temporarily greater or temporarily less than the first speed, so that the following distance can be achieved, then the second speed reverts to a speed substantially similar to the first speed.

As the first speed may not remain consistent throughout operation of the plurality of mining trucks 10 on the worksite 14, the second speed may modulate based on changes to the first speed, so that consistent following between the first mining truck 20 and the second mining truck 22 may be achieved, as shown in block 140. In some examples, modulation of the second speed may further be based on the following distance 70, such that the following distance 70, determined at block 125, may be maintained.

The method 100 may control propulsion of the second mining truck 22 based on the second speed determined by other steps of the method 150, as shown in block 150. Propulsion may be controlled by the second controller 37 transmitting instructions a drive of the second mining truck 22. In some examples, controlling propulsion of the second mining truck 22 includes increasing propulsion, such as when the portion of the worksite 14 is substantially level (e.g., the example shown in FIG. 4) or when the portion of the worksite 14 includes an uphill grade 72, as shown in the example traffic pattern for the plurality of mining trucks 10 in FIG. 5. Alternatively, in some examples, controlling propulsion of the second mining truck 22 may include retarding the propulsion, such as when the portion of the worksite 14 includes a downhill grade 74, as shown in the example traffic pattern for the plurality of mining trucks 10 in FIG. 6. In such examples, retarding of the propulsion may be achieved by employing automated control of brakes associated with the second mining truck 22.

In some examples, an operator of the second mining truck 22 may receive confirmation that the truck speed is being limited under the control of the method 100, such that machine behavior of the second mining truck 22 remains predictable. For example, a display associated with the controller 37 may inform the operator of the second mining truck 22 that the speed of the second mining truck 22 may be limited based on the control of the method 100. The operator inputs for propel and retard may still be employed in conjunction with the method 100, making adjustments only to reduce speed, so as to maintain machine distance at, for example, a predetermined following distance.

Additionally, when controlling propulsion at block 150, the method 100 may again determine if the following distance is equal to the predetermined optimal length between trucks, as shown in block 157. If the following distance is equal or substantially similar to the predetermined optimal length between trucks, then the method 100 returns to block 110. Otherwise, the method 100 may continue to block 160.

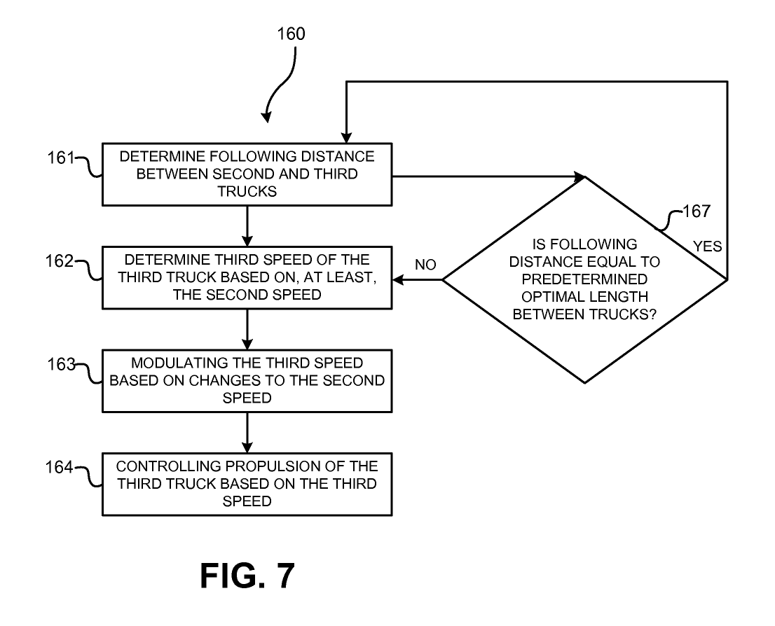

Blocks 125-150 may be repeated for any number of other mining trucks of the plurality of mining trucks 10. As shown in FIG. 7, with continued reference to FIG. 3, the method 100 may further include blocks 161-165 which, respectively, are similar to blocks 125-150, but for controlling propulsion of the third mining truck 24 with respect to the second mining truck 22. Similar to block 125, at block 161 a second following distance 76, between the second mining truck 22 and the third mining truck 24, may be determined. At block 162, a third speed of the third mining truck 24 may be determined based on, at least, the second speed of the second mining truck 22, which is performed similarly to the functions of block 130. After determining the following distance between the second and third mining trucks 22, 23, the method 100 may determine if the following distance is equal to the predetermined optimal length between trucks, as shown in block 167, which is similar to block 127. If the following distance is equal or substantially similar to the predetermined optimal length between trucks, then the method 100 returns to block 161. Otherwise, the method 100 continues to block 162. Similar to block 140, at block 164 the method 100 may include modulating the third speed of the third mining truck 24 based on the second speed. At block 165, the method 100 may further include controlling propulsion of the third mining truck 24 based on the third speed, similar to the propulsion control of the second mining truck 22 described with reference to block 150.

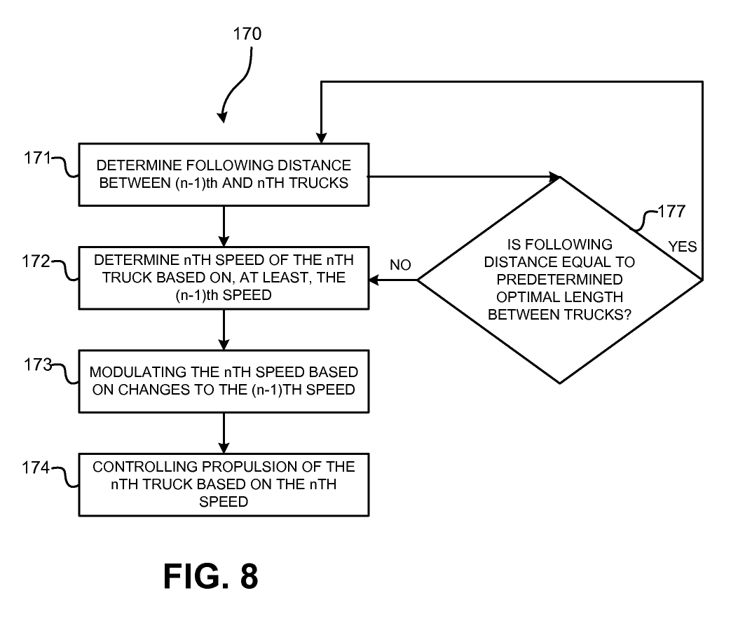

As similarly shown in FIG. 8, with continued reference to FIG. 3, the method 100 may further include blocks 171-177 which, respectively, are similar to blocks 125-150, but for controlling speed of the nth mining truck 25 with respect to an (n-1)th mining truck. At block 171, a following distance, between the (n-1)th mining truck and the nth mining truck 25, may be determined. After determining the following distance between the nth and (n-1)th mining trucks, the method 100 may determine if the following distance is equal to the predetermined optimal length between trucks, as shown in block 177, which is similar to block 127. If the following distance is equal or substantially similar to the predetermined optimal length between trucks, then the method 100 returns to block 171. Otherwise, the method 100 continues to block 172. At block 172, a nth speed of the nth mining truck 25 may be determined based on, at least, the (n-1)th speed of the (n-1)th mining truck. At block 174 the method 100 may include modulating the nth speed of the nth mining truck 25 based on the (n-1)th speed. At block 175, the method 100 may further include controlling propulsion of the nth mining truck 25 based on the third speed, similar to the propulsion control of the second mining truck 22 described with reference to block 150.

The systems and methods of the present disclosure may further be used to prevent collisions between multiple members of the plurality of mining trucks 10. For example, using the method 100, above, controlling propulsion of the second mining truck 22 relative to the propulsion of the first mining truck 20 may maintain following distance 70 between the first and second mining trucks 20, 22 to prevent end-to-end collisions when the second mining truck 22 follows the first mining truck 20.

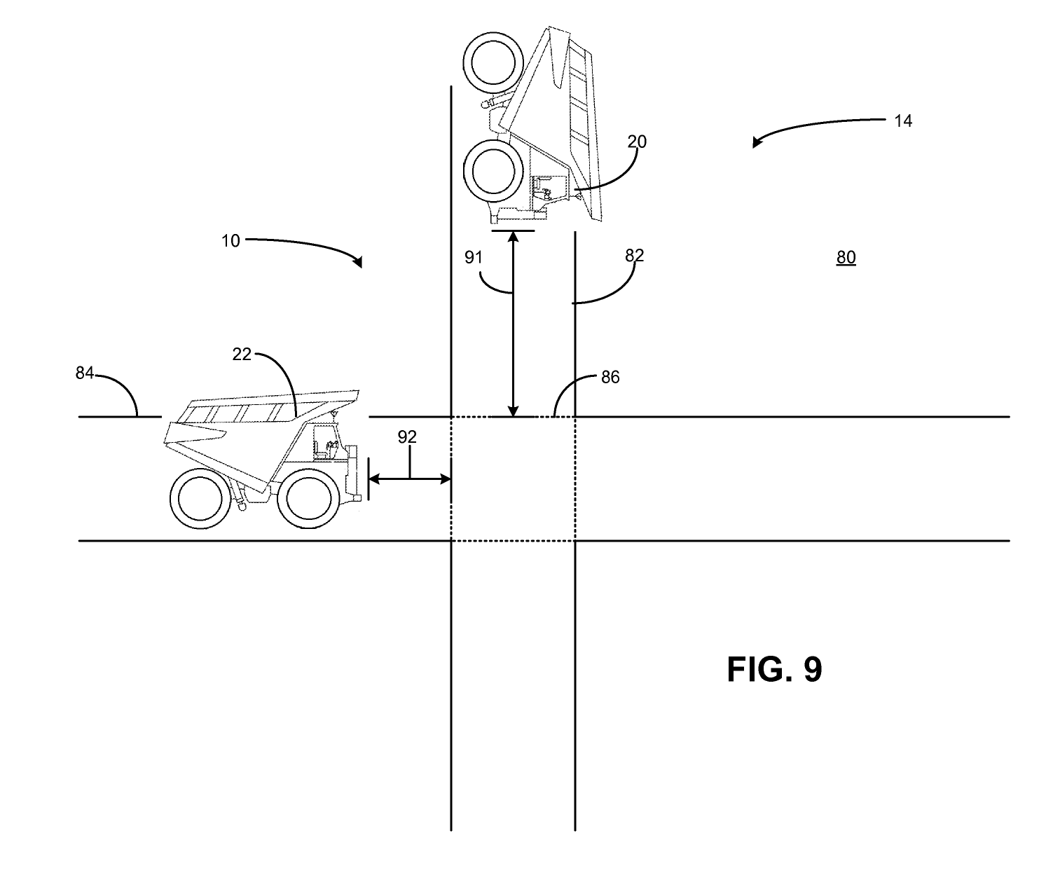

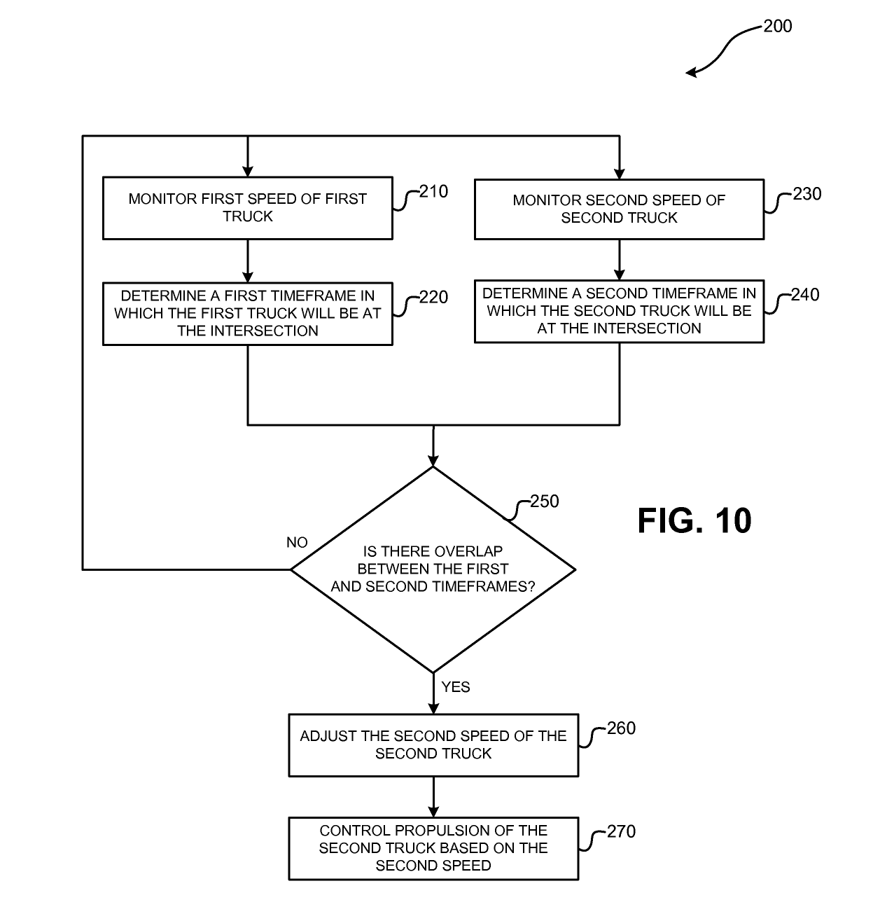

Additionally, the system 12 may be employed to prevent collisions between the first and second mining trucks 20, 22, when the first and second mining trucks 20, 22 are travelling, respectively, on first and second roads 82, 84 of the worksite 14, wherein the first and second roads 82, 84 meet at an intersection 86, as illustrated in the example map of FIG. 9. A method 200, as illustrated in the flowchart of FIG. 10, may be employed by the system 12 to prevent collisions by altering the propulsion of the second mining truck 22 based on the speed of the first mining truck 20.

The method 200 may begin at block 210 and/or block 230 by monitoring the first speed of the first mining truck 20 and/or the second speed of the second mining truck 22. Monitoring the first speed and/or second speed may be accomplished using any of the sensors 42, 44, 45, the positioning systems 46, 48, 49, or any other sensor, method, or apparatus for determining speed of the first mining truck 20. Monitoring the first speed at block 210 may be executed by the first controller 36, but may also be executed by any additional controllers (e.g., controllers 37, 39) connected to the network communication system 60 and in communication with the first controller 36. Similarly, monitoring the second speed at block 230 may be executed by the second controller 37, but may also be executed by any additional controllers (e.g., controllers 36, 39) connected to the network communication system 60 and in communication with the second controller 37.

At block 220, the method 200 may include determining a time frame in which the first mining truck 20 will reach the intersection 86. The timeframe, as described herein, may refer to any period in time in which the first mining truck 20, in whole or in part, is located within the bounds of the intersection 86. For example, in FIG. 9, the first mining truck 20 is shown on the first road 82 at a first distance 91, the first distance 91 measured between a boundary of the first mining truck 20 and the bounds of the intersection 86. The timeframe, in this example, would be the period in time starting after the first mining truck 20 travels the course of the first distance 91 and enters the intersection 86 and ending when the entire first mining truck 20 exits the intersection 86.

Similarly, at block 240, the method 200 may include determining a second timeframe in which the second mining truck 22 will reach the intersection 86. The second timeframe, as described herein, may refer to any period in time in which the second mining truck 22, in whole or in part, is located within the bounds of the intersection 86. For example, in FIG. 9, the second mining truck 22 is shown on the second road 83 at a second distance 92, the second distance 92 measured between a boundary of the first mining truck 22 and the bounds of the intersection 86. The second timeframe, in this example, would be the period in time starting after the second mining truck 22 travels the course of the second distance 92 and enters the intersection 86 and ending when the entire second mining truck 22 exits the intersection 86.

Block 250 may determine if there is any overlap in time between the timeframe of the first mining truck 20 and the second timeframe of the second mining truck 22. If there is an overlap in timeframes, then the first and second mining trucks 20, 22 may collide at the intersection 86 unless one or both of the first and second speeds are adjusted. Therefore, if the timeframes overlap, then the method 200 continues to block 260, wherein the second speed of the second mining truck 22 may be adjusted; otherwise, the method 200 returns to blocks 210 and/or 230 and continues to monitor the first and second speeds of the first and second mining trucks 20, 22.

At block 250, a second speed of the second mining truck 22 is adjusted based on, at least, the first speed of the first truck and the timeframe. Determination of the second speed may be performed at any controller 36, 37, and/or 39 connected to the network communication system 60. Determining the second speed may include altering the second speed if the first truck and the second truck, at least in part, will reach the intersection 86 at a substantially similar point in time.

The second speed may be configured such that the second mining truck 22 will not be, in whole or in part, in the intersection 86 during the timeframe. The second speed may be configured such that the second mining truck 22 does not travel the entirety of a second distance 92, prior to the timeframe. In such examples, the determining the second speed may include decreasing the second speed such that the first mining truck 20 will pass the intersection 86 before the second mining truck 22 reaches the intersection 86. Alternatively, the second speed may be configured such that the second mining truck 22 travels the entirety of the second distance 92 and the length of the intersection 86, prior to the timeframe. In such examples, the determining the second speed may include increasing the second speed such that the second mining truck 22 will pass the intersection 86 before the first mining truck 20 reaches the intersection 86.

The method 200 may control propulsion of the second mining truck 22 based on the second speed determined by other steps of the method 200, as shown in block 240. Propulsion may be controlled by the second controller 37 transmitting instructions a drive of the second mining truck 22. In some examples, controlling propulsion of the second mining truck 22 includes increasing propulsion, such as when the second road 84 of the worksite 14 is substantially level or when the second road 84 of the worksite 14 includes an uphill grade. Alternatively, in some examples, controlling propulsion of the second mining truck 22 may include retarding the propulsion, such as when the portion of the worksite 14 includes a downhill grade. In such examples, retarding of the propulsion may be achieved by employing automated control of brakes associated with the second mining truck 22.

By managing traffic patterns of mining trucks during mining operations using any of the foregoing systems and methods, productivity on the worksite may increase. For example, by employing the method 100 and/or the method 200, the plurality of mining trucks 10 may be able to operate with shorter distances between the members of the plurality of mining trucks 10, because automated propulsion of downstream trucks may allow safer travel at close distances, as compared to operation with operator controlled trucks. When the gaps between the members of the plurality of mining trucks 10 (e.g., the following distance 70) decrease, additional trucks may be added to the plurality of mining trucks 10 that would otherwise not fit on the worksite 14.

Additionally, the systems and methods disclosed may increase safety on the worksite by preventing collisions between members of the plurality of mining trucks 10. For example, when the method 100 is employed, collisions between closely following mining trucks, like the first and second mining trucks 20, 22, may be prevented because the second speed of the second mining truck 22 would be modulated in response to a sudden decrease in speed of the first mining truck 20. Reaction time of a computerized automated system may be shorter than reaction time by a human operator. Further, due to the system 12 having controller-to-controller communication amongst the controllers 36, 37, 38, 39, levels of latency of data transmission may be improved upon, when compared to systems having a centralized instructor (e.g., a foreman site sending controls to all machines from a centralized communication center). Lower latency may improve response time for stopping, thus preventing collisions and allowing for safe, short following distances between members of the plurality of mining trucks 10. Further, the system 12 may execute the method 200 to also control the second speed of the second mining truck 22, when members of the plurality of mining trucks 10 encounter one another at intersections on the worksite 14, which may improve safety on the worksite 14.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method for monitoring and controlling a plurality of mining trucks while the plurality of mining trucks operate on a worksite, the plurality of mining trucks including at least a first truck and a second truck, the method comprising:
monitoring a first speed of the first truck;
determining a second speed of the second truck based on, at least, the first speed;
modulating the second speed based on changes to the first speed; and
controlling propulsion of the second truck based on the second speed.

2. The method of claim 1, further comprising having the second truck follow the first truck, and wherein determining the second speed of the second truck is further based on a following distance between the first truck and the second truck, and modulating the second speed is further based on maintaining the following distance.

3. The method of claim 2, wherein the plurality of mining trucks further includes a third truck, the third truck following the second truck, the method further comprising:
determining a third speed of the third truck based on, at least, the second speed;
modulating the third speed based on changes to the second speed; and
controlling propulsion of the third truck based on the second speed.

4. The method of claim 3, wherein the determining the third speed of the third truck is further based on a second following distance between the second truck and the third truck, and modulating the third speed is further based on maintaining the second following distance.

5. The method of claim 2, further comprising determining the following distance based on an operating condition associated with one of the first truck or the second truck.

6. The method of claim 5, wherein the operating condition is at least one of a load of the first truck or the second truck, engine health of the first truck or the second truck, momentum of the first truck or the second truck when entering a road of the worksite from a grade of the worksite, propulsion capabilities of the first truck or the second truck, drive system torque capabilities of the first truck or the second truck, or braking capabilities of the first truck or the second truck.

7. The method of claim 1, wherein the first truck and the second truck operate on a downhill grade of the worksite, and controlling propulsion of the second truck based on the second speed includes retarding propulsion while travelling downhill on the downhill grade.

8. The method of claim 1, wherein controlling propulsion of the second truck based on the second speed includes utilizing a throttle lock feature of the second truck to implement the second speed.

9. A method for monitoring and controlling a plurality of mining trucks while the plurality of mining trucks operate on a worksite, the plurality of mining trucks including at least a first truck and a second truck, the worksite including a first road and a second road, the first road and second road intersecting at an intersection and the first truck travelling on the first road towards the intersection and the second truck travelling on the second road towards the intersection, the method comprising:
monitoring a first speed of the first truck;
determining a timeframe in which the first truck will reach the intersection based on the first speed;
determining a second speed of the second truck based on, at least, the first speed and the timeframe; and
controlling propulsion of the second truck based on the second speed.

10. The method of claim 9, wherein determining the second speed of the second truck based on, at least, the first speed and the timeframe includes altering the second speed if the first truck and the second truck, at least in part, will reach the intersection at a substantially similar point in time.

11. The method of claim 9, wherein determining the second speed of the second truck further includes increasing the second speed such that the second truck will pass the intersection before the first truck reaches the intersection.

12. The method of claim 9, wherein determining the second speed of the second truck further includes decreasing the second speed such that the first truck will pass the intersection before the second truck reaches the intersection.

13. A system for monitoring and controlling a plurality of mining trucks while the plurality of mining trucks operate on a worksite, the plurality of mining trucks including, at least, a first truck and a second truck, the system including:
a network communication system configured to enable communication amongst the plurality of mining trucks;
a plurality of controllers associated with the plurality of mining trucks, each of the plurality of controllers being operatively associated with one of the plurality of mining trucks, the plurality of controllers including, at least, a first controller operatively associated with the first truck and a second controller operatively associated with the second truck, the plurality of controllers being in communication via the network communication system, the plurality of controllers being configured to:
control propulsion of the first truck based on a first speed,
communicate the first speed amongst the plurality of mining trucks via the network communication system;
determine a second speed for the second truck based on, at least, the first speed, and
control propulsion of the second truck based on the second speed.

14. The system of claim 13, wherein the plurality of controllers is further configured to modulate the second speed based on changes to the first speed.

15. The system of claim 14, wherein the second truck follows the first truck and the plurality of controllers is further configured to:
determine the second speed of the second truck based on a following distance between the first truck and the second truck, and
modulate the second speed based on maintaining the following distance.

16. The system of claim 15, further comprising one or more sensors operatively associated with at least one of the first truck or the second truck, the one or more sensors being configured to detect an operating condition associated with at least one of the first truck and the second truck, and wherein the plurality of controllers is further configured to determine the following distance based on the operating condition.

17. The system of claim 13, further comprising a central dispatch configured to relay communications amongst the plurality of controllers via the network communication system.

18. The system of claim 13, wherein the worksite includes a first road and a second road, the first road and second road intersecting at an intersection and the first truck travelling on the first road towards the intersection and the second truck travelling on the second road towards the intersection, wherein the plurality of controllers is further configured to:
determine a timeframe in which the first truck will reach the intersection based on the first speed, and
communicate the timeframe amongst the plurality of mining trucks via the network communication system, and
modulate the second speed based on the timeframe.

19. The system of claim 13, further comprising a throttle lock system associated with the second truck and wherein the plurality of controllers is further configured to receive signals from the plurality of controllers to maintain propulsion of the second truck based on the second speed.

20. The system of claim 13, further comprising a manual control mechanism associated with the first truck and configured to provide manual control signals to the plurality of controllers, and wherein the plurality of controllers is further configured to:
receive the manual control signals from the manual control mechanism, and
determine the first speed based on the manual control signals.
